(19) United States
(12) Patent Application Publication
(10) Pub. No.: US 2021/0120635 A1
(43) Pub. Date: Apr. 22, 2021

(54) Radiant Heating and Display Mirror

(71) Applicant: Hall Labs LLC, Provo, UT (US)

(72) Inventors: David R. Hall, Provo, UT (US); Arjun Krishna, Orem, UT (US); Jeremy Johnson, Salem, UT (US); Ramon Velasco, Orem, UT (US); Pedro Sol, Provo, UT (US)

(73) Assignee: Hall Labs LLC, Provo, UT (US)

(21) Appl. No.: 16/656,172

(22) Filed: Oct. 17, 2019

(51) Int. Cl. H05B 3/84; H05B 3/74

(52) U.S. Cl. CPC H05B 3/845; H05B 3/746

(57) ABSTRACT

The invention is a heating and display mirror. The mirror is composed of two different “zones”, one for heating and one for display. The heating zone is heated by radiant heat, and the display zone features a display device that produces lighted images visible on the mirror's surface. The heating and display zones are operated by user controls, which give instructions to the heating zone to turn on and off, and to the display zone regarding what images to display on the lighted display device.

### TECHNICAL FIELD

The present invention relates to radiant heating devices.

### BACKGROUND

Various solutions exist for heating spaces. Heat can be provided to a complete building (central heat), such as a residence, by a furnace that heats air, e.g. by combustion of a gas, which heated air is blown through vents into the buildings room (forced air). Alternatively, a boiler can heat water, oil or other fluids that circulate through pipes or “radiators” to heat rooms with radiant heat.

Some situations call for “space heaters,” namely heaters that are designed for providing heat to a single space within a building. Space heaters can also use forced air, i.e. heating air and blowing it into the room, or radiant heat, i.e. heating a fluid in a radiator or using heating elements that radiate heat into the room. Naturally, safety is a critical concern for any space heater, especially since most space heaters sit on the floor, where they might be touched by a child or a pet, or even worse, where they might be knocked over and come into contact with something flammable.

Some space heaters utilize reflective material and radiant heat to create a heating mirror. An advantage to heating mirrors is that they do not take up very much space and are functional as both a heater and mirror, but they carry an added safety concern. When there is no visual distinction between a mirror and a heating mirror, it is likelier that a person comes into contact with the hot surface of the heating mirror, since they would not expect the surface of a mirror to be hot.

A separate enhancement to the simple mirror is connectivity to the Internet or various user devices. Such a mirror is sometimes known as a “smart mirror”. With a connection to the Internet, smart mirrors can curate and display information helpful to users, from the current time to weather forecasts and news headlines.

### SUMMARY

In a first aspect, the invention is a heating and display mirror. The mirror is composed of two different “zones”, one for heating and one for display. The heating zone is heated by radiant heat, and the display zone features a display device that produces lighted images visible on the mirror's surface. The heating and display zones are operated by user controls, which give instructions to the heating zone to turn on and off, and to the display zone regarding what images to display on the lighted display device.

In a second aspect, the invention includes a pentiometer in order to adjust the voltage supplied to the heating zone, and in turn adjust the amount of heat produced. In a third aspect, the invention includes a temperature sensor and a thermostat function, which adjusts the heat in accordance with a desired temperature as set by a user. In a preferred embodiment, a temperature sensor is adapted to measure the heat of the mirror's surface, and send signals to the controller that prevent the surface temperature to go beyond a maximum, as set by factory standards or the user.

In another aspect, the mirror includes a visual indicator that, in conjunction with the surface temperature sensor, informs the user when the mirror is in certain states, including heating, warm, and off (neither heating nor warm). A preferred aspect includes this visual indicator as part of the display zone.

In a preferred aspect, the invention includes sensors, both attached and remote, that collect data and send signals to the wireless communication device, which the controller interprets and sends instruction to the heating zone or display zone as appropriate. Preferably, these include light, motion, temperature, and humidity sensors. Also, a preferred embodiment includes a speaker, enabling functions such as playing music, and alerting the user of various information aurally. A microphone is also included, which the user can use to provide voice instructions. The preferred embodiment also has a light to illuminate the user, and an embedded camera to enable the user to capture images hands-free.

In another aspect, the display zone also includes a touch-sensitive sensor, for controlling the display zone as well as the heating zone. In an additional aspect, the wireless communication device is adapted to send and receive information to other smart devices. Examples include a user's smart phone, as well as other smart devices in the house such as windows and window coverings, a smart thermostat, and an internet-enabled alarm clock.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an exploded view of a radiant heating and display mirror.

FIG. 2 is an exploded view of a different embodiment of a heating and display mirror.

FIG. 3 is a front view of the preferred heating and display mirror of the present invention.

FIG. 4 is an illustration depicting an embodiment of the heating and display mirror with certain functions featured, in a residential setting.

FIG. 5 is an additional illustration of a heating and display mirror in a residential setting, with other functions featured.

FIG. 6 is a detailed view of the various controls and communication devices.

FIG. 7A depicts a smart phone running an app to control a plurality of functions of a heater and display mirror.

FIG. 7B depicts the smart phone of FIG. 7, displaying a different screen of the app, which depicts information shared from a heating and display mirror.

FIG. 7C depicts the smart phone of FIG. 7, displaying a different screen of the app.

FIG. 7D depicts the smart phone of FIG. 7, displaying a different app that is adapted to communicate with a heating and display mirror.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, and unless indicated otherwise, the term “mirror” refers to an object that reflects light in such a way that, for incident light in some range of wavelengths, the reflected light preserves many or most of the detailed physical characteristics of the original light, thereby producing a reflection of what is placed before it.

As used herein and unless indicated otherwise, the term “current” and “electrical current” is meant to refer to electrical current, whether conducted as alternating current (AC) or direct current (DC).

As used herein, the term “transparent” is used to refer to materials that allow light to pass through so that objects behind can be distinctly seen.

As used herein, the term “silvered” as in, for example, a “silvered layer” or “silvered backing,” is used to refer to a backing of a silver-colored or other reflective material in order to make a transparent layer reflective.

As used herein, the term “radiant heat” is used to describe various forms of heat in the form of electromagnetic radiation, rather than convention or convection.

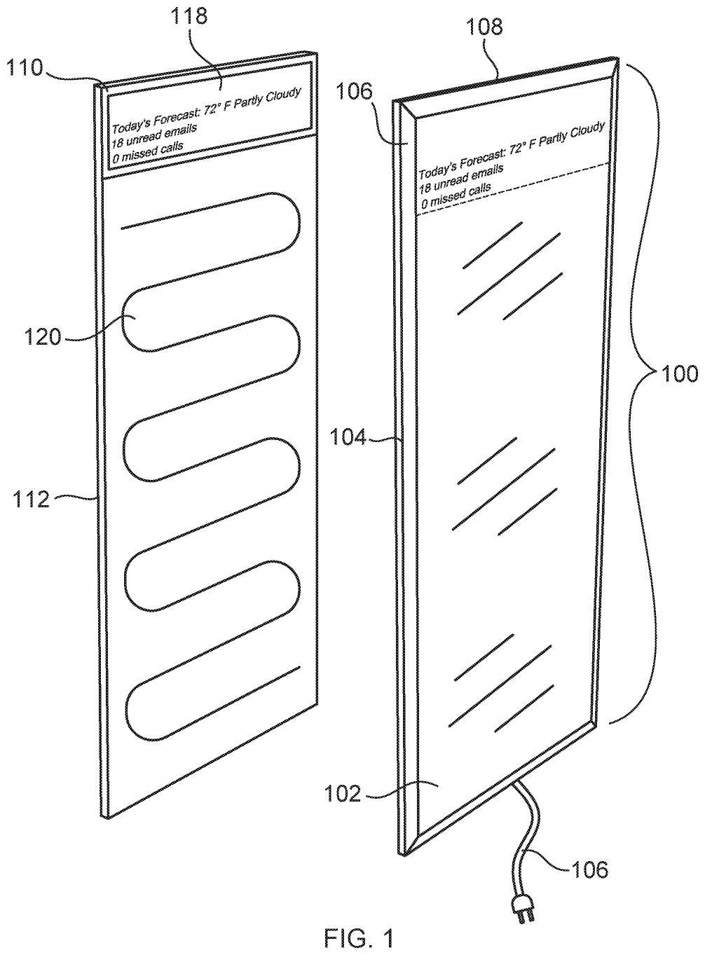

Referring to FIG. 1, the depicted embodiment of the invention is a heating and display mirror 100 adapted to hang on a wall. The mirror includes a sheet of glass 102 and a conventionally silvered backing. In the most preferred embodiment, the mirror includes beveled edges 108. In some embodiments, the mirror includes a frame surrounding the glass. Nevertheless, beveled or rounded edges should make the frame unnecessary. In the depicted embodiment, the heating and display mirror 100 includes a plug 106 for inserting into a conventional outlet. In the most preferred embodiment, the mirror is designed with a cavity in the back of the mirror so that the cord and plug are hidden behind the mirror in use. In alternative embodiments, the heater is hard-wired, i.e. connected directly to the building's electrical system.

The heating and display mirror 100 is demarcated into two separate “zones”, the heating zone 104 and display zone 106. Visible in an exploded view of the mirror 100, a second layer of the mirror is itself divided into two distinct zones, heating zone 112 and display zone 110. The heating zone 112 includes a radiant heating device, and the display zone 110 includes a display device.

The preferred shape and dimensions of the mirror and included heating and display zones depends on various factors. Naturally, aesthetics are important to consider. While rectangular shapes are generally preferred, in some situations, a round, oval or other shape may be desirable. The dimensions should be selected so as to be aesthetically pleasing as well as functional. The display zone should be large enough to display detailed images, but not so large that it inhibits the functionality of the heating zone or the general uses for a mirror. In heating and display mirror 100 the display zone is located above the heating zone and proportionately smaller than the heating zone. The relative location and size of the display and heating zones will vary depending on the shape of the mirror, its intended usage within the residence, or other factors. Although in the tall rectangular shape, the placement of the display zone above the heating zone is convenient for a user to see while standing in front of it, other sized mirrors in different residential functions may be optimized by placing the display zone in a completely different spot. Additionally, although not depicted in this embodiment, the display zone may be surrounded by the heating zone, i.e. not located along the edge of the mirror. Shipping considerations should also be taken into account.

A feature of the display zone 110 is a display device 118. Display device 118 is adapted to show any series of images, which are visible in the display zone 106. The display zone 106 is comprised of a transparent layer through which the images from the display device 118 can be seen. The display device 118 is designed to illuminate the images it produces, so that they are easily visible in the display zone 104. In a preferred embodiment, the display device is adapted to adjust the illumination of its screen, so as to optimize visibility and energy efficiency. The screen illumination may be adjusted to adapt to its surroundings with a controller and a light sensor. The light sensor may send signals to the controller through a hardwired data connection, or via a wireless communication device.

The heating layer 112 provides radiant heat via a current source and resistive wire 120. Radiant heat is produced when current travels through the resistive wire 120. The resistive wire may be arranged as depicted, or in other forms, including but not limited to a coil, connected vertical rows, or connected horizontal rows. However, other embodiments of the heating layer may produce radiant heat through alternative methods.

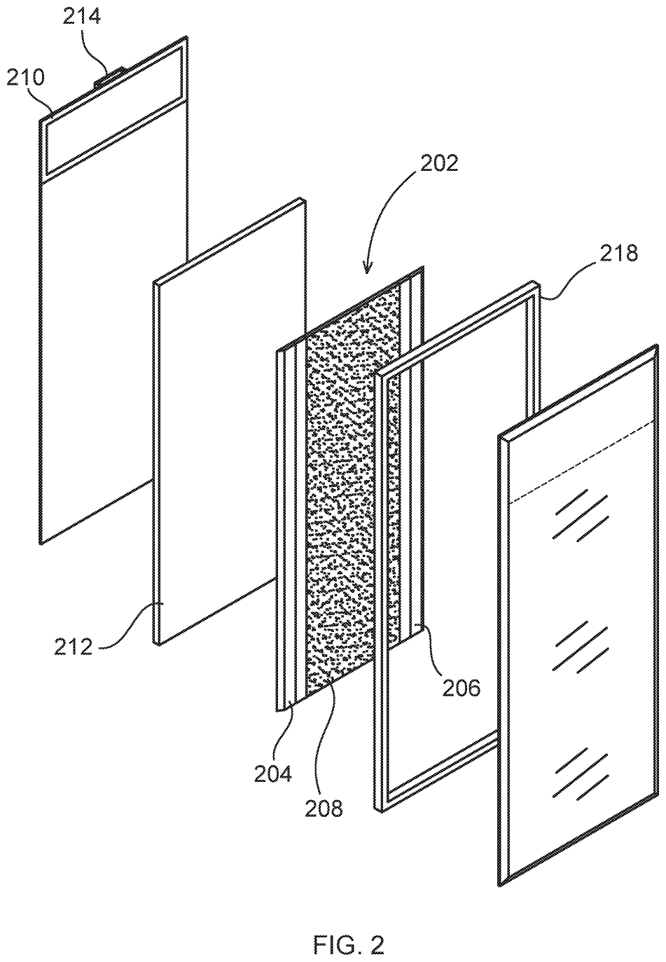

As depicted in FIG. 2, one embodiment of the heating layer 202 produces radiant heat through a continuous sheet of resistive material. Referring to FIG. 2, the heating layer 202 includes a first elongated conductor 204 and a second elongated conductor 206. Preferably, these elongated conductors are identical and in the form of a metallic ribbon. The metal in the ribbon can be selected from any suitably conductive metal or metal alloy, such as copper, copper alloys, aluminum alloys and the like. Most preferably, the conductors are formed from a conventional copper alloy. The dimensions for the elongated conductors are selected in view of the overall dimensions of the heating zone and the desired heat output. Preferably, the elongated conductors are between 9 and 12 mm wide and between 350 and 500 μm thick. Most preferably, the elongated conductors are about 10 mm wide and about 450 μm thick

Referring again to FIG. 2, between the elongated conductors 204 and 206 is a continuous sheet of resistive material 208 adapted to produce heat in response to electrical current. Such sheets can be referred to as electrothermal materials or coatings. In general, these materials comprise some type of conductive particles dispersed within a polymer matrix. While metal particles can be used, the expense and large coefficient of thermal expansion make these less favored. Preferably, the particles are carbon. More preferably, the carbon is in the form of nanoparticles. Most preferably, the carbon nanoparticles and the polymer matrix are those described in U.S. Published Patent Application No. 2016/0185983. In fact, the present inventors purchased sheets of resistive material under the trademark Nanoxene® from the inventors named in U.S. Published Patent Application No. 2016/0185983 and their company, Life-E, located in Sandy Utah.

As shown in FIG. 2, a preferred construction is to have the two elongated conductors 204 and 206 and the continuous sheet 208 laminated between two layers of a transparent polymer film. In this way, the conductors 204 and 206 and the continuous sheet 208 can be inserted into the mirror as a unit. Naturally, the polymer film is chosen so as to withstand the heat the sheet 208 will generate.

The properties and dimensions of the elongated conductors and the sheet of resistive material are selected so as to produce the desired range of heat produced by the heater and the surface temperatures desired for the heater. Preferably, the resistive sheet is between 5 and 35 centimeters across, i.e. between the conductors, more preferably between 30 and 35 centimeters, and most preferably 34 centimeters. At this most preferred width, the Nanoxene® material produces about 150 watts per meter. Thus, with the most preferred height of the mirror being about 1.115 meters, the wattage of the heater is about 170 watts.

The preferred embodiment also includes a backing layer 210, which should have thermal insulating properties. Preferably, the backing layer comprises a backing sheet and a sheet of insulating material 212. This can be an important feature in preventing the heater from heating up the wall it is attached to and to direct heat forward. Most preferably, the sheet of insulating material 212 includes a metallic foil film that helps reflect radiant heat forward.

Preferably, the heater also includes a frame 218 for holding the heating layer 202, the sheet of insulating material and the backing sheet 107 together. Most preferably, this frame is made from an extruded aluminum alloy.

The backing layer 210 should also have a wall mounting element, such as a hook or bracket 214 for mounting the heater on a wall. Alternatively, the mounting element can employ an adhesive, such as a peel-and-stick pressure-sensitive adhesive pad or pads.

Naturally, safety is the most important factor in designing any heater. The heater of the present invention is designed so that the surfaces never exceed safe temperatures, i.e. 70° C. Preferably, the surfaces of the heater never exceed 68° C., more preferably 65° C. and most preferably 60° C. These maximum temperatures are preferably set at the factory. In the depicted embodiment 100 the maximum temperature on the front of the mirror should be about 65° C.

In the simplest embodiment, the heater is merely switched on by the user when heat is needed and switched off by the user when it is not. Alternatively, the heater includes a settable thermostat, whereby the user sets the desired temperature to which the heater heats its environment. Alternatively, the thermostat can be used to enter a desired maximum temperature and/or a desired minimum temperature. Feedback for the thermostat may come from on onboard thermal sensor or transducer. Alternatively, the feedback may come from a remote sensor or device.

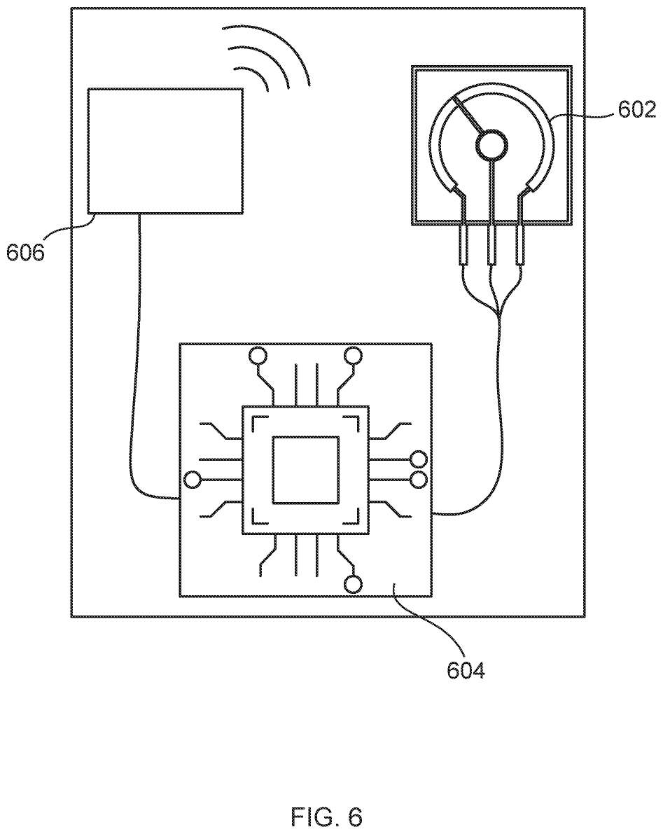

Again, in the simplest embodiment, the heater is designed to either be on or off, whether put in that state by the user or a controller. As seen in FIG. 6, in alternative embodiments, the heater includes a potentiometer 602 or other analog or digital device for varying the amount of power delivered to the heating layer, and thus changing the amount of heat generated. The use of of pentiometer 602 in the preferred embodiment allows for the heating and display mirror to warm up quickly and then radiate a specified amount of heat to maintain a desired temperature. In the preferred embodiment, the controls 604 receive data from a user and sensors to signal the optimal heat level, and thus, voltage, to pentiometer 602. In this way, the heater can be programmed for a quicker heating ramp or a slower one.

In the preferred embodiment shown in FIGS. 1-5, the preferred transparent layer 102 is a sheet of glass. Alternative embodiments use other transparent material, such as transparent polymers, including poly (methyl methacrylate), acrylic, polycarbonate and polypropylene.

The transparent layer 102 is a mirror. Preferably, this reflective layer is applied as a coating on the back of the transparent layer. This can be referred to as a silvered backing or coating. The most preferred material for silvering is aluminum, although silver, gold, tin and other shiny metals and alloys may be used. Alternatively, a sheet of reflective material may be used in place of a transparent layer to fulfill the function of a mirror.

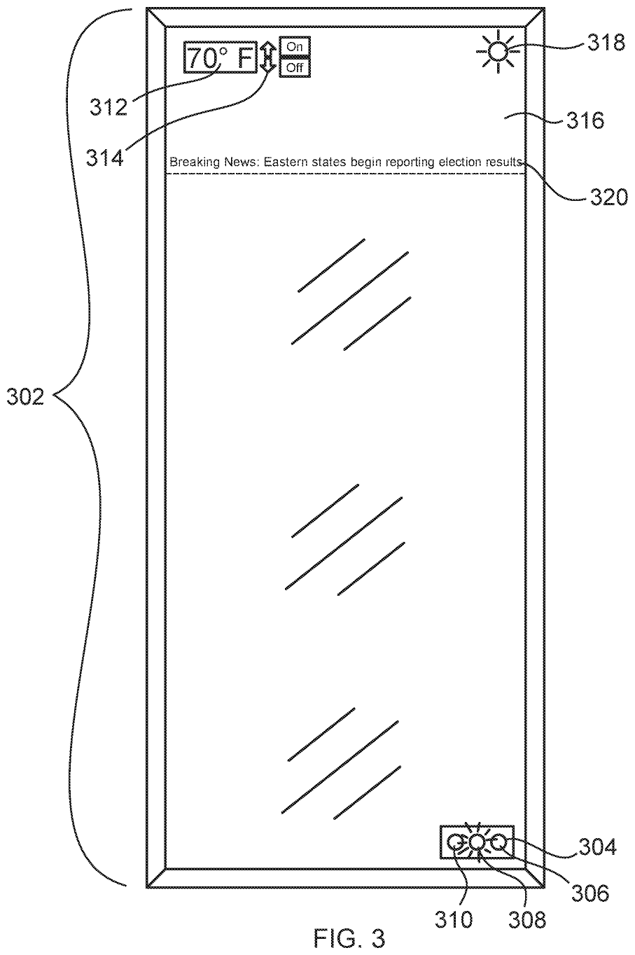

Referring to FIG. 3, one embodiment of the heating and display mirror 302 includes a visual indicator in the form of a display 304. Display 304 includes three separate lighted areas to communicate information to a user. The three different indicators in display 304 light up to indicate one condition, and when the indicators are not lit, a different condition is communicated to the user. In the embodiment depicted by display 304, one indicator 306 is lit when the surface temperature of the mirror is hot. Indicator 308 is lit when the mirror is heating, and indicator 310 is lit when a specified temperature has been reached. In this way, display 304 communicates to a user in clear signals if the device is heating, if the device is hot, or if a specified temperature has been reached.

To differentiate the different indicators, in one embodiment each indicator is a different color. For example, the indicator that indicates the surface of the mirror is hot is a red color, so that a user can quickly ascertain that, when the red light is on, the surface of the mirror is too hot to touch. In this embodiment, the indicator for warming could be yellow, and the indicator for when the desired temperature is reached is green.

With indicator 308 communicating that the mirror is heating, a user can know a number of useful things. For example, if the room they are in with the mirror feels cold, they can tell by the light indicator if the mirror is currently warming the room, or if settings need to be changed or controls set to turn on the heating device. The indicator 310 that indicates a desired temperature has been met further gives the user information to adjust the settings or controls. If the user is too warm, and indicator 310 is lit, the user may choose to turn the heating device off, or the user may choose to lower the desired temperature and allow the controls and pentiometer to adjust the heat accordingly. Indicator 306 takes into account the fact that the surface of the mirror remains warm for a time even after the heating device is turned off. Knowing that the surface of the mirror is not hot allows the user to touch the mirror without worry. There are certain times that the user would want to know the mirror surface is not hot, such as when they would like to clean or move the mirror. Additionally, the user may take extra precaution when the surface of the mirror is hot, such as ensuring small children are not left unsupervised near the mirror.

Display 304 is one embodiment of these three indicators, but this same information can be communicated to the user in different formats, or the indicators may be used to communicate different information. Alternatively, an embodiment of the indicator display could have a greater or smaller number of indicators than display 304. The preferred embodiment includes indicators for the three conditions described, but the indicators are incorporated into the display zone. In the preferred embodiment, the indicator that the mirror is hot, and the mirror is heating, are displayed digitally within the display zone, and are not independently illuminated.

Referring to FIG. 3, in one embodiment there is a readout 312 within the display zone that shows the temperature of the surface of the mirror and/or the ambient temperature of the air around the mirror. User controls 314 include “up” and “down” buttons and an on/off switch located adjacent to the temperature display 312, to adjust the set temperature or turn off the heating function. These controls may be physical buttons, as depicted in FIG. 3. In the most preferred embodiment, the entire display zone is touch-sensitive, and the controls are part of a larger digital “touch screen”.

FIG. 3 also shows that the heating and display mirror 302 includes display zone 316. Display zone 316 includes a transparent surface and display device. Preferably, the display device is connected to an information source, so as to provide information about things such as the weather (such as through an icon 318), headlines (320), calendar items, and/or task lists. Preferably, the information source is the user's smart phone. Alternatively, the information source may be provided by a direct connection to the internet.

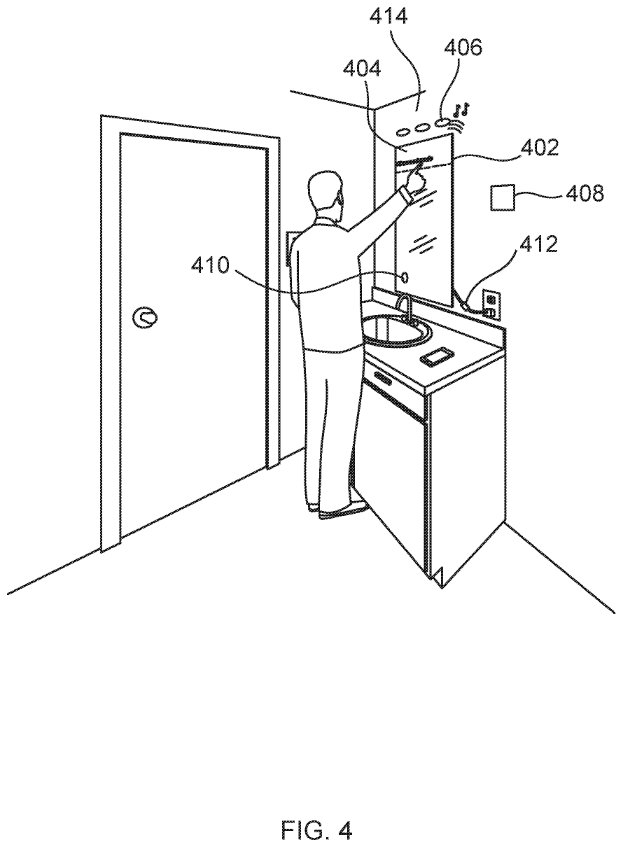

In the most preferred embodiment, the display zone does not only display information, but also receives signals from the user via a touch-sensitive screen, as depicted in FIG. 4. Referring to FIG. 4, the user is providing instructions to the mirror 402 by touching the display zone 404. In this way, the user may interact with the mirror in a number of ways beyond controlling the heating function. For example, a user could scroll through news headlines, and choose to display a full article they are interested in reading by double-tapping the headline. Or, a user could not only see the current day's forecast, but also view the forecast for upcoming days. The preferred display device is integrated with the user's smart phone to prominently display any notifications and alerts received by the user's smart phone. In this way, a user could read and send text messages, interact on social media, and be alerted when new emails are received, which are only a few of the many functions a user could perform with a touch-sensitive display zone that is connected to a user's smart phone.

In the preferred embodiment, the display device is also able to receive instructions via a connected microphone. Additionally, in the most preferred embodiment, the display and heating mirror is equipped with a speaker 414. With voice commands, the user can not only control the heating device but also functioning of the display device. The speaker 414 on the display device 402 can be used a number of ways. The user may wish to listen to music while they are getting ready for the day, or play a daily newst podcast. Additionally, the user is able to stream audiovisual contect on the display device.

FIG. 4 illustrates the preferred heating and display mirror 402 hung on the wall in a bathroom. This is a particularly preferred environment of the mirror. For one thing, users typically like the bathroom to be heated a bit higher than the rest of the home, especially in the morning, and because users generally get wet. For another, a heating mirror can prevent fogging, that is condensation of moisture on the mirror, during activities such as showering. Additionally, many people begin their day with a hygiene routine in front of the bathroom mirror, and so the many informative and interactive functions of the display zone may be especially germane at the start of the day.

As shown, the mirror 402 includes the display zone 404. The mirror 402 in the bathroom preferably includes lights 406 for illuminating the bathroom, and particularly for illuminating the user in front of the mirror. Preferably, the lights 406 are controlled through the touch-sensitive display zone 404. Most preferably, the lights 406 are dimmable.

The mirror 402 also preferably includes at least one sensor 408. Sensor 408 is a remote sensor, although the mirror may have sensors within the mirror's construction. Sensor 408 detects motion. This sensor can be used to detect when a person walks into the bathroom. In response, the heating mirror may be programmed to automatically turn itself on and start heating the bathroom. The mirror may also be programmed so that the lights 406 turn on in response to someone entering the room.

The sensor or sensors 410 may also be used to detect the forming of or potential for forming of moisture droplets on the mirror (fogging). Sensor 410 on the mirror's surface detects when water droplets are on the mirror; an alternative sensor could measure the general moisture level in the room. In response, the heater may be activated to prevent or ameliorate fogging. In the preferred embodiment, when the heater is activated by a humidity sensor, a “fog reduction” heat setting is switched on, which emits a lower amount of heat than what is generally used to heat up a room.

The sensor or sensors (410) may also be used to detect temperature. Preferably, the sensor detects the temperature of the air in front of the mirror. Most preferably, this is accomplished by an infrared sensor. As such, this temperature data can be used by the mirror to determine if the heater should be on or off, or the level of heat produced by the heater, so as to maintain the temperature of the bathroom at the level set by the user. Alternatively, the sensor detects the temperature of the mirror and extrapolates to the temperature of the air in the bathroom.

The mirror 402 also preferably includes a switch 412 for interrupting current to the mirror, to thereby cut power to the mirror. Alternatively, the heater and/or display device can be turned off via touch-sensitive controls in the display zone.

In some embodiments, the heater is activated by a motion sensor, to detect someone entering the room. In other embodiments, the heater is turned on and off with the lights in that room. For, as someone turns on the lights as he enters the bathroom, he is also turning on the heating mirror. As he turns off the lights and leaves, he is also turning off the heating mirror. In yet other embodiments, the heater is designed to turn off after a certain period of time from being turned on, or after a certain period of time after the motion sensors detect motion.

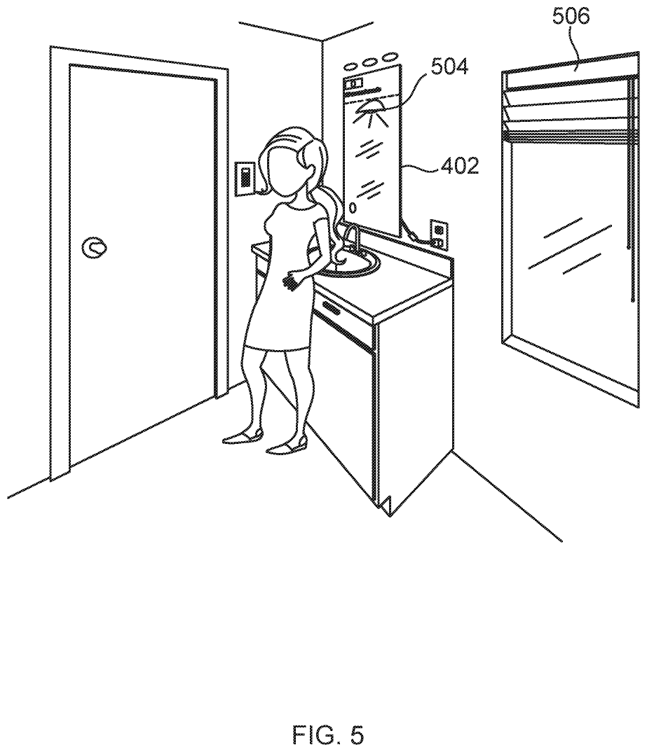

FIG. 5 depicts an alternative set up for the heating and display mirror 402. Mirror 402 includes a camera 504. The camera may be controlled by touch controls on the display zone, or wirelessly via the user's smart device. Camera 504 is designed to be unobtrusive to the general design and function of the mirror. The camera is designed to capture the approximate image that is reflected in the mirror. The user may make use of camera 504 in a number of ways. As one example, a user may take a picture and then send it to their friends asking for opinions on an outfit choice. Alternatively, a user may wish to upload the pictures onto social media. Also, as pictured in FIG. 5, the user can use the camera to take a picture of what would otherwise be difficult for the user to view in the mirror, such as the back of a hairstyle.

Preferably, the mirrors of the present invention can be controlled wirelessly. More preferably, the mirrors of the present invention can be controlled as elements in an “Internet of Things” fashion as part of a “smart home” and programmed with devices, such as those using IFTTT programming. Referring to FIG. 6, the mirrors of the invention preferably include a controller 604 with a programming module configured to execute instructions, at least for turning the heater on and off. Other instructions could be to set the amount of power delivered to the heating layer. Also, to fit the mirror for IoT and smart home operation, the heater preferably includes a wireless communication device 606, communicating with the controller, whereby a user can turn the heater on and off and enter programming instructions. Wireless communication can take place over the Internet, via a Bluetooth connection, or a connected network of all or some of the IoT devices within a home. The wireless communication device also enables the mirror to send and receive information from remote sensors and other IoT devices.

The heating and display mirror may connect to other smart home, or IoT, devices. In one embodiment, the heating and display mirror may share information and controls with an automated window to optimize the user experience. For example, the mirror 402 could send instructions to automated window 506 to close when the heating zone is activated. Such controls can be overridden by a user, but they are generally designed to increase heating efficiency.

Preferably, the user communicates with the controller by means of a smart phone running an app. Through that app, the user also receives feedback information about the state of the mirror. Most preferably, the app is adapted to control and receive feedback from multiple IoT devices.

In alternative embodiments, the mirror is supplied with a dedicated remote control device. Preferably, that remote control device can be mounted on the wall of the room. When a dedicated remote control device is used, it is preferable to incorporate a temperature sensor, so that it can give feedback to the heater as to the temperature within the room.

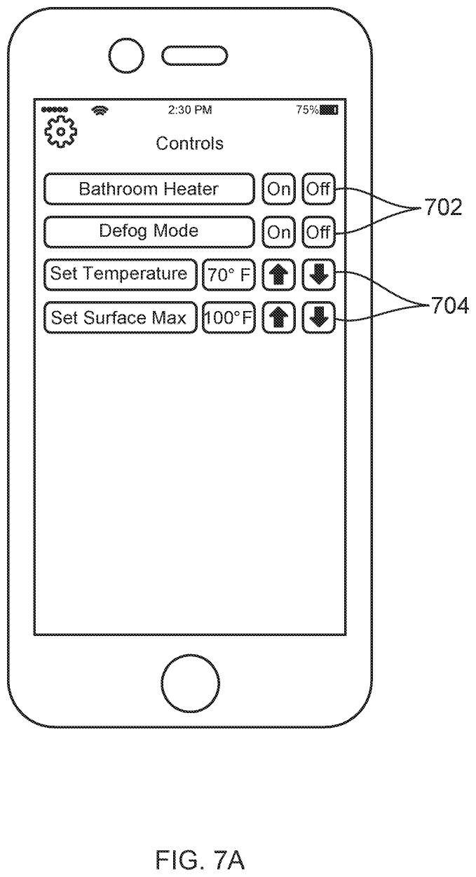

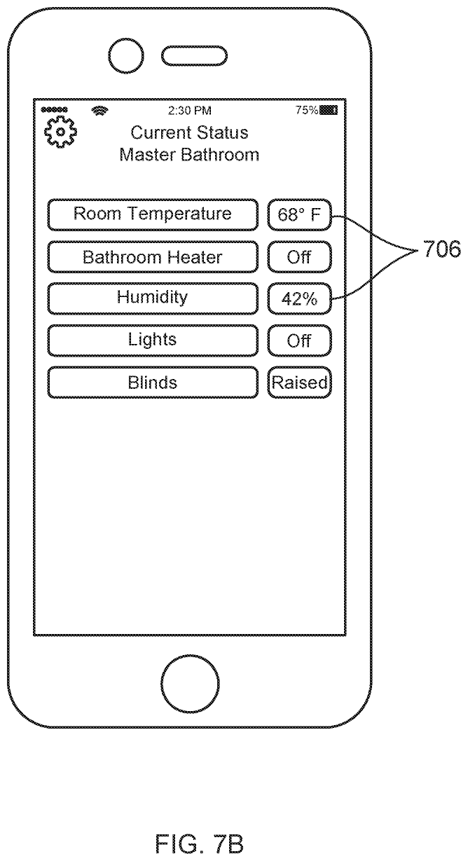

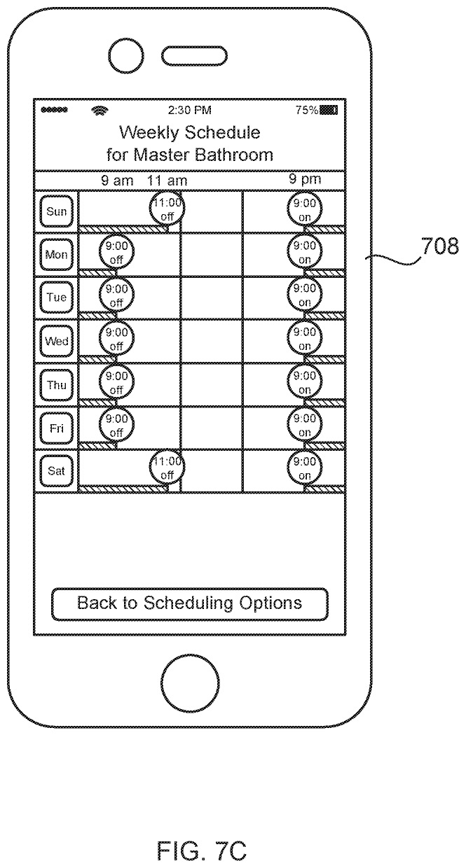

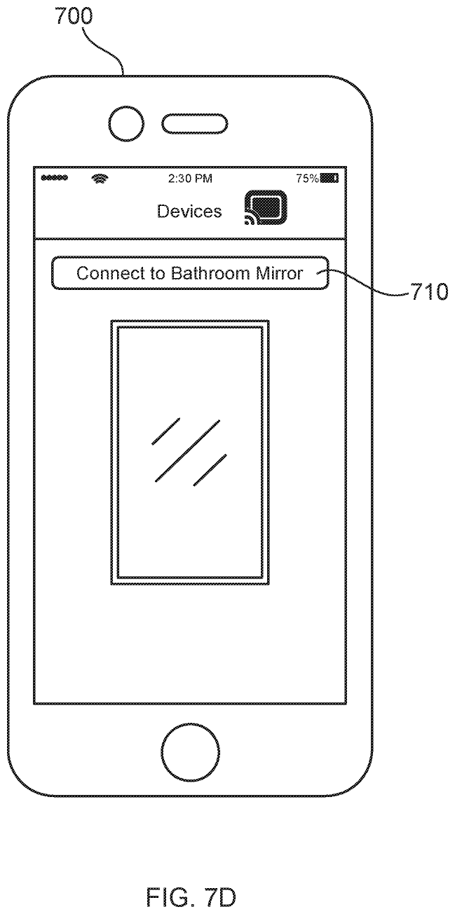

FIGS. 7A-7D depict screenshots of a smart phone running such an app. FIG. 7A depicts a screenshot of basic controls for the heating element within the mirror. Controls 702 enable a user to turn the heating element on and off, as well as set the heater to its defogging setting. Controls 704 fine tune control of the heater when it is on, with use of a settable thermostat. Controls 704 also allow the user to set a maximum surface temperature of the mirror, a safety measure that prevents the surface of the mirror from overheating. Unless instructed otherwise, the mirror will not radiate more heat, even when the set temperature has not been met, if the set surface maximum temperature has been reached.

FIG. 7B depicts a screenshot of the app displaying information received from the mirror and its affiliated sensors and devices. Display 706 gives information to the user that may be relevant when the user is in the same room as the mirror, but it is primarily useful for when the user is not in the same room as the mirror. The room temperatures can be obtained from sensors mounted to the heaters. Alternatively, the room temperatures can be obtained from separate sensors, for example, mounted on other IoT devices in those rooms. Display 706 communicates to a user if the lights or heater is on, something they may wish to check after they have left the room. Other information depicted in display 706 is the current room temperature, humidity level, and status of connected IoT blinds.

FIG. 7C depicts yet another screenshot of the app which illustrates weekly scheduling options 708. As can be seen, the user is able to set a weekly schedule of when that particular heater is turned on and off. In this way, the user is able to set, for example, the bathroom heater to come on early enough so the bathroom is warm when he or she enters in the morning. Living spaces can be heated during expected times of occupancy. For example, the heater can be turned on in the morning so as to warm up spaces before people arise, turned off if everyone is away at work during the day, turned on again before people return from work and then turned off again for the nighttime. The energy savings and added comfort of such programming are tangible.

FIG. 7D depicts a screenshot of the smart phone 700 interacting with the display device. The user may use a number of existing apps, such as chromecast or Apple's screen mirroring, if they wish to synch their smart phone display 710 with the display device. The user may wish to use this to stream audio and/or video content directly to the device.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A heating and display mirror comprising:
a planar sheet of a material adapted to reflect light from a front surface thereof, the planar sheet being divided between a heating zone and a display zone;
a heating device disposed behind the heating zone and adapted to produce radiant heat in response to applying current thereto;
a digital display disposed behind the display zone and adapted to produce lighted images that are visible on the front surface in the display zone;
user controls, whereby a user can provide instructions;
a wireless communication device adapted to receive instructions and send feedback; and
a controller adapted to
receive instructions via the wireless communication device and via the user controls;
control the level of heat produced by the heating device according to the instructions; and
control the images produced by the digital display device according to the instructions.

2. The invention of claim 1, further comprising a potentiometer for adjusting voltage delivered to the thin heating device to thereby adjust the amount of heat generated by the heating device and wherein the controller is adapted to control the potentiometer.

3. The invention of claim 2, further comprising a settable thermostat, whereby a desired temperature can be set by a user by a program within the controller, or via the wireless communication device.

4. The invention of claim 3, wherein the thermostat is set with a maximum temperature to prevent the heater from reaching unsafe temperatures.

5. The invention of claim 1, further comprising a visual indicator for indicating to the user one or more of the following conditions: the device is on, the device is off, the device is warming, the device has reached a preset temperature, and the device is hot.

6. The invention of claim 5, wherein the visual indicator is visible in the display zone.

7. The invention of claim 1, wherein the user controls comprise a touch screen in the display zone.

8. The invention of claim 1, wherein the user controls respond to voice commands and wherein the heating and display mirror provides audio feedback to a user.

9. The invention of claim 1, wherein the digital display is connected via the controller and the wireless communication device to a wireless network and configured to display one or more of the following: exterior temperature, weather conditions, news headlines, calendar events, apparel suggestions and task lists.

10. The invention of claim 1, wherein the controller receives instructions via the wireless communication device from a user's smart device, whereby images are provided for the digital display.

11. The invention of claim 1, further comprising a speaker whereby audio content can be played for a user, and wherein the images and audio content are provided by a user's smart device via the wireless communication device.

12. The invention of claim 1, wherein a user can use a smart device to turn the heater on and off, as well as enter one or more of the following instructions: programming options, adjust the thermostat, and select what the digital display displays.

13. The invention of claim 1, wherein the controller comprises a programming module configured to receive and execute instructions for turning the heater on and off.

14. The invention of claim 1, wherein a user provides instructions to the controller via a smart device running an app and receives feedback information about the state of the mirror through the app.

15. The invention of claim 1, wherein the controller is adapted to receive signals from sensors.

16. The invention of claim 15, wherein the sensors are selected from the group consisting of a humidity sensor, a light sensor, a motion sensor, and a temperature sensor, and combinations thereof.

17. The invention of claim 15, wherein the controller is also adapted to receive a signal from a humidity sensor, and wherein the controller is further adapted to, in response to a signal indicating a humidity over a pre-set threshold, operate the mirror in a fog-reduction mode by controlling the level of heat produced by the heating device to at least reduce condensation on the mirror.

18. The invention of claim 1, wherein the mirror further comprises a light to illuminate a user.

19. The invention of claim 1, wherein the mirror further comprises a camera adapted to send captured images to the display zone and the wireless communication device.

20. The invention of claim 1, wherein the heating device comprises: a first elongated conductor configured to pass electric current; a second elongated conductor configured to pass electric current and spaced apart from and parallel to the first elongated conductor; and a continuous sheet of resistive material disposed between the first and second elongated conductors and adapted to produce heat in response to electrical current.
